(19) United States
(12) Patent Application Publication
(10) Pub. No.: US 2008/0107308 A1
(43) Pub. Date: May 8, 2008

(54) Medical biometric identification security system

(76) Inventors: Michael Ward, Saline, MI (US); Ryan J. Verhey-Henke, Ann Arbor, MI (US); Sandra A. Johanesen, Ann Arbor, MI (US); Cynthia Zhu, Livonia, MI (US)

Correspondence Address: Siemens Corporation;Intellectual Property Department, 170 Wood Avenue South, Iselin, NJ, 08830, US

(21) Appl. No.: 11/299,642

(22) Filed: Dec. 12, 2005

Related U.S. Application Data
(60) Provisional application No. 60/635,449, filed on Dec. 13, 2004.

(51) Int. Cl. G06K 9/00

(52) U.S. Cl. 382/115

(57) ABSTRACT

A system manages access to patient medical information based on biometric identification information. A repository stores biometric information for multiple users. A biometric interface receives biometric information from a user. An access processor authorizes access, by a user, to requested medical information of a particular patient, by comparing biometric information received via the biometric interface with stored biometric information in the repository, to identify a matching user with predetermined authorized entitlement to access the medical information of the particular patient. An audit processor stores, in an audit record, data identifying: biometric information of the matching user, a patient identifier of the particular patient, and time and date of access to the medical information of the particular patient.

### CROSS-REFERENCE TO RELATED APPLICATIONS

The present application is a non-provisional application of provisional application having Ser. No. 60/635,449 filed by Michael Ward, et al. on Dec. 13, 2004.

### FIELD OF THE INVENTION

The present invention generally relates to computer information systems. More particularly, the present invention relates to a medical biometric identification security system.

### BACKGROUND OF THE INVENTION

Computer information systems (“systems”) include computers that communicate with each other over a network, such as the Internet, and computers that manage information. For example, a healthcare enterprise uses systems to store and manage medical information, reports, and documents for patients in their care.

Present systems for signing of medical reports and other received documents rely on a password based challenge/response system. Such systems typically perform authentication by challenging the user to enter a password or password phrase to sign a document. If the password or password phrase matches a preset criterion, the event is recorded, and the document is considered signed.

A problem with the present password based system is that the system does not positively identify the user signing the report. The system merely identifies the user at the computer terminal that knows the correct password or password phrase.

In the present password based system, passwords or password phrases may be stolen or derived by unauthorized means, thereby compromising integrity and security of the user's signature. Present password based systems are unable to determine whether the actual user is authorized to sign the presented documents.

Another deficiency in the present systems is that specified computers in a healthcare facility permit presentation and signing of medical documents, thereby restricting a user's review and signature of the documents to the location of those specified computers.

Accordingly, there is a need for a medical biometric identification security system that addresses these deficiencies and related problems.

### SUMMARY OF THE INVENTION

A system manages access to patient medical information based on biometric identification information. A repository stores biometric information for multiple users. A biometric interface receives biometric information from a user. An access processor authorizes access, by a user, to requested medical information of a particular patient, by comparing biometric information received via the biometric interface with stored biometric information in the repository, to identify a matching user with predetermined authorized entitlement to access the medical information of the particular patient. An audit processor stores, in an audit record, data identifying: biometric information of the matching user, a patient identifier of the particular patient, and time and date of access to the medical information of the particular patient.

### BRIEF DESCRIPTION OF THE DRAWINGS

FIG. 1 illustrates a medical biometric identification security system, in accordance with invention principles.

FIG. 2 illustrates a general method for the system, as shown in FIG. 1, in accordance with invention principles.

FIG. 3 illustrates a particular method for the system, as shown in FIG. 1, in accordance with invention principles.

### DETAILED DESCRIPTION OF THE PREFERRED EMBODIMENTS

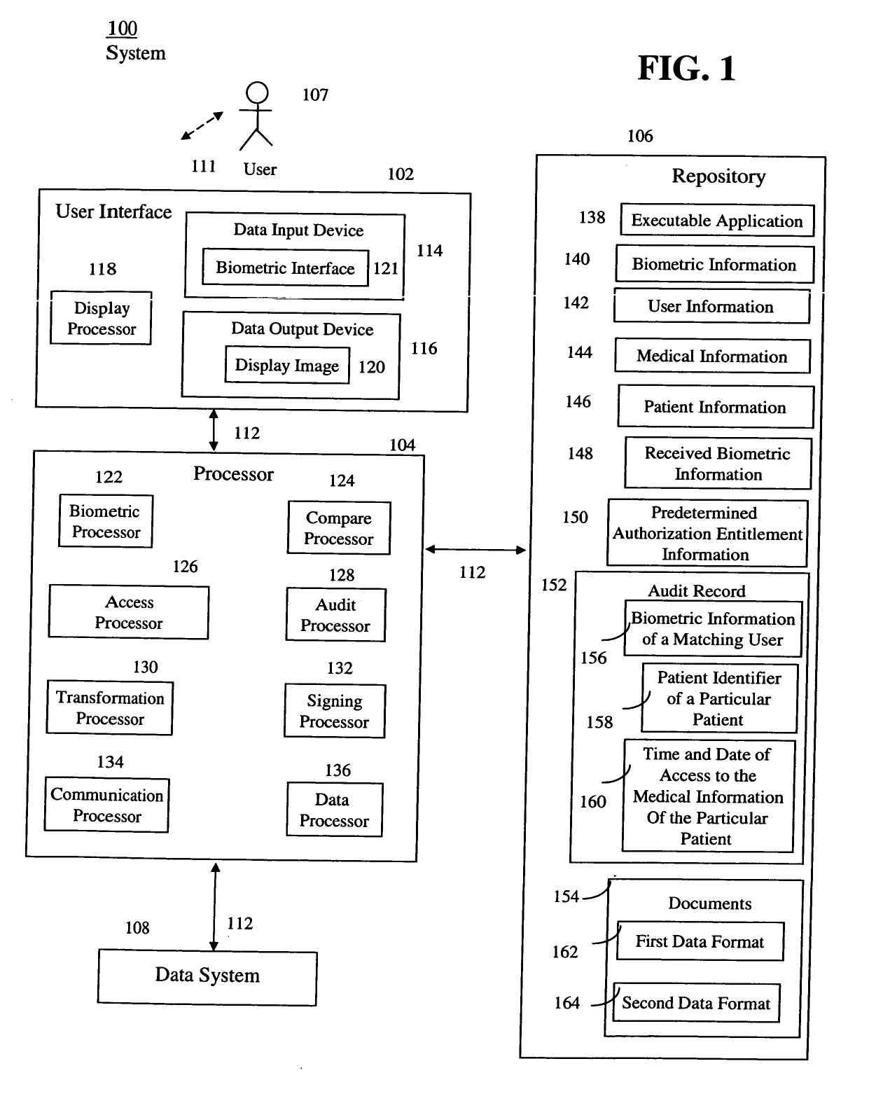

FIG. 1 illustrates a medical biometric identification security system (i.e., “system”). The system 100 includes a user interface 102, a processor 104, and a repository 106. A user 107 and a data system 108 interact with the system 100.

A communication path 112 interconnects elements of the system 100, and/or interconnects the system 100 with the data system 108. The dotted line near reference number 111 represents interaction between the user 107 and the user interface 102.

The user interface 102 further provides a data input device 114, a data output device 116, and a display processor 118. The data input device 114 further includes a biometric interface 121 permitting the user 107 to input the user's biometric information into the system 100. The data output device 116 further provides one or more display images 120, which are presented for viewing by the user 107.

The processor 104 further includes a biometric processor 122, a compare processor 124, an access processor 126, an audit processor 128, a transformation processor 130, a signing processor 132, a communication processor 134, and a data processor 136.

The repository 106 further includes an executable application 138, biometric information 140, user information 142, medical information 144, patient information 146, received biometric information 148, predetermined authorization entitlement information 150, and audit record 152, and documents 154. The audit record 152 further includes biometric information of a matching user 156, a patient identifier of a particular patient 158, and time and date of access 160 to the medical information of the particular patient. The documents 154 further comprise data identifying a first data format 162 and a second data format 164.

The data system 108 represents a source and/or a destination of any information that may be needed or used by the system 100 including, for example, any of the information stored in the repository 106. The information may be pushed to the system 100 and/or pulled by the system 100, automatically and/or manually, at one time, periodically, or as needed. Likewise, the information may be pushed to the data system 108 and/or pulled by the data system 108, automatically and/or manually, at one time, periodically, or as needed.

The system 100 may be employed by any type of enterprise, organization, or department, such as, for example, providers of healthcare products and/or services responsible for servicing the health and/or welfare of people in its care. For example, the system 100 represents a healthcare information system. A healthcare provider provides services directed to the mental, emotional, or physical well being of a patient. Examples of healthcare providers include a hospital, a nursing home, an assisted living care arrangement, a home health care arrangement, a hospice arrangement, a critical care arrangement, a health care clinic, a physical therapy clinic, a chiropractic clinic, a medical supplier, a pharmacy, a doctor's office, and a dental office. When servicing a person in its care, a healthcare provider diagnoses a condition or disease, and recommends a course of treatment to cure the condition, if such treatment exists, or provides preventative healthcare services. Examples of the people being serviced by a healthcare provider include a patient, a resident, a client, and an individual.

The system 100 may be fixed and/or mobile (i.e., portable). The system 100 may be implemented in a variety of forms including, but not limited to, one or more of the following: a personal computer (PC), a desktop computer, a laptop computer, a workstation, a minicomputer, a mainframe, a supercomputer, a network-based device, a personal digital assistant (PDA), a smart card, a cellular telephone, a pager, and a wristwatch.

The system 100 and/or elements contained therein also may be implemented in a centralized or decentralized configuration. The system 100 may be implemented as a client-server, web-based, or stand-alone configuration. In the case of the client-server or web-based configurations, the executable application 138 may be accessed remotely over a communication network, represented by communication path 112.

The communication path 112 (otherwise called network, bus, link, connection, channel, etc.) represents any type of protocol or data format. The protocol or data format includes, but is not limited to, one or more of the following: an Internet Protocol (IP), a Transmission Control Protocol Internet protocol (TCPIP), a Hyper Text Transmission Protocol (HTTP), an RS232 protocol, an Ethernet protocol, a Medical Interface Bus (MIB) compatible protocol, a Local Area Network (LAN) protocol, a Wide Area Network (WAN) protocol, a Campus Area Network (CAN) protocol, a Metropolitan Area Network (MAN) protocol, a Home Area Network (HAN) protocol, an Institute Of Electrical And Electronic Engineers (EEE) bus compatible protocol, a Digital and Imaging Communications (DICOM) protocol, and a Health Level Seven (HL7) protocol.

The user interface 102 permits bidirectional exchange of data between the system 100 and the user 107 of the system 100 or another electronic device, such as a computer or an application, for example.

The data input device 114 typically provides data to a processor in response to receiving input data either manually from a user or automatically from another electronic device. For manual input, the data input device is a keyboard and a mouse, but also may be a touch screen, or a microphone and a voice recognition application, for example.

The biometric interface 121 in the data input device 114 provides a hardware and/or software interface adapted to receive biometric information from the user.

The data output device 116 typically provides data from a processor for use by a user or another electronic device. For output to a user, the data output device 116 is a display, such as, a computer monitor or screen, that generates one or more display images 120 in response to receiving the display signals from the display processor 118, but also may be a speaker or a printer, for example. The display images 120 generate any information in any format including information used by a healthcare enterprise, such as any information/data stored in the repository 106. Examples of display images 120 include, for example, text, graphics, photos, images, graphs, charts, etc.

The display processor 118 (e.g., a display generator) includes electronic circuitry or software or a combination of both for generating the display images 120 or portions thereof in response to receiving data representing display images, which may be stored in the repository 106. The data output device 116, implemented as a display, is coupled to the display processor 118 and displays the generated display images 120. The display images 120 provide, for example, a graphical user interface, permitting user interaction with the processor 104 or other device. The display processor 118 may be implemented in the user interface 102 and/or the processor 104.

The system 100, elements, and/or processes contained therein may be implemented in hardware, software, or a combination of both, and may include one or more processors, such as processor 104. A processor is a device and/or set of machine-readable instructions for performing task. The processor includes any combination of hardware, firmware, and/or software. The processor acts upon stored and/or received information by computing, manipulating, analyzing, modifying, converting, or transmitting information for use by an executable application or procedure or an information device, and/or by routing the information to an output device. For example, the processor may use or include the capabilities of a controller or microprocessor.

The data processor 136 performs general data processing for the system 100. The communication processor 134 manages communications within the system 100 and outside the system 100, such as, for example, with the data system 108.

The biometric processor 122 receives biometric information upon user interaction 111, via the biometric interface 121, processes the user's biometric information, and stores the user's biometric information 148 in the repository 106. Typically, the biometric processor 122 encodes raw user biometric information as a message digest and/or applies other cryptographic techniques, before storing the received biometric information 148 in the repository 106. However, the biometric processor 122 may also store raw user biometric information in the repository 106, for a purpose of audit logging, for example.

The compare processor 124 compares the user's biometric information 148 to biometric information 140, associated with user information 142 of one or more users, to identify a matching user with predetermined authorized entitlement 150 to access the medical information of the particular patient.

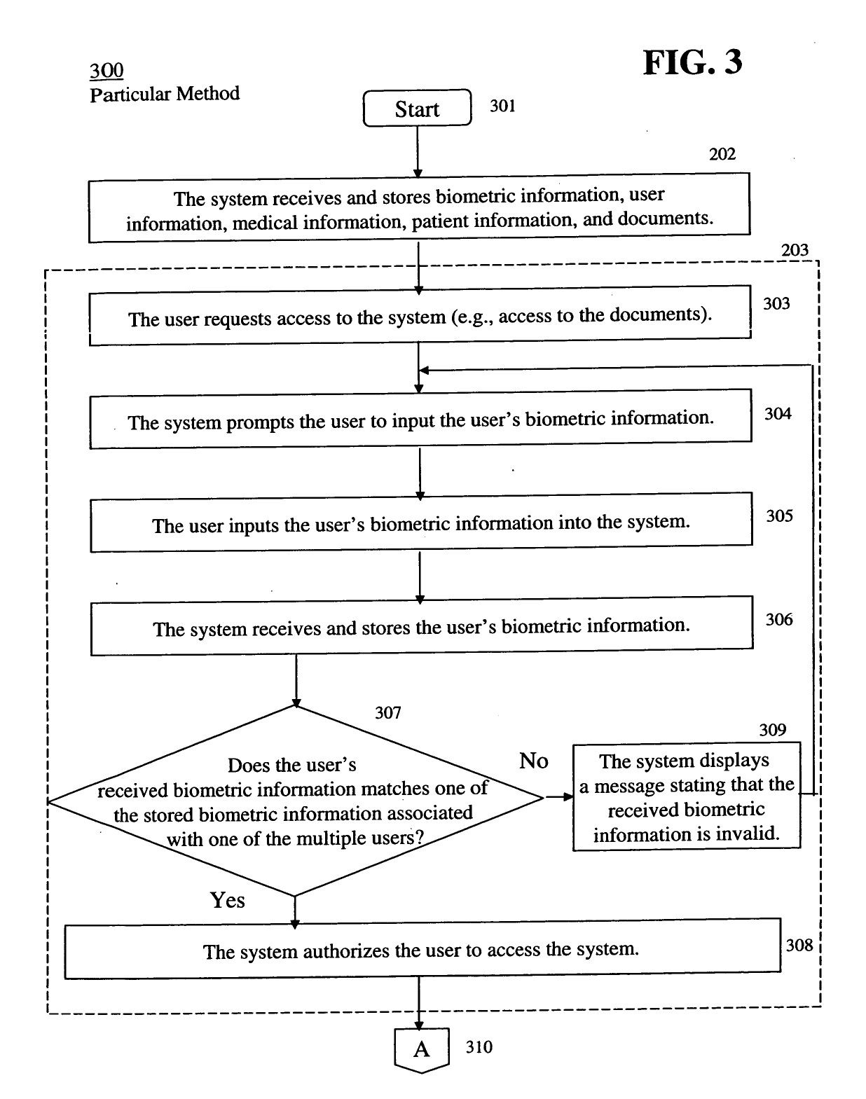

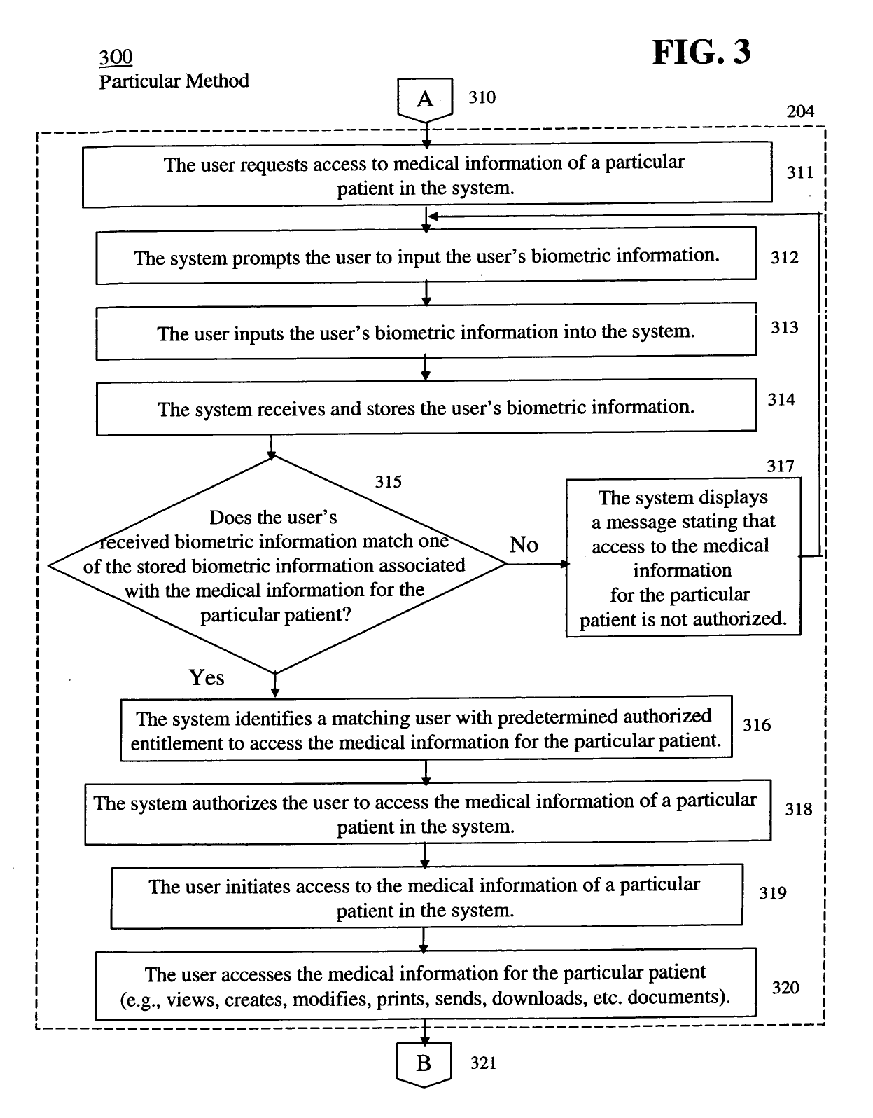

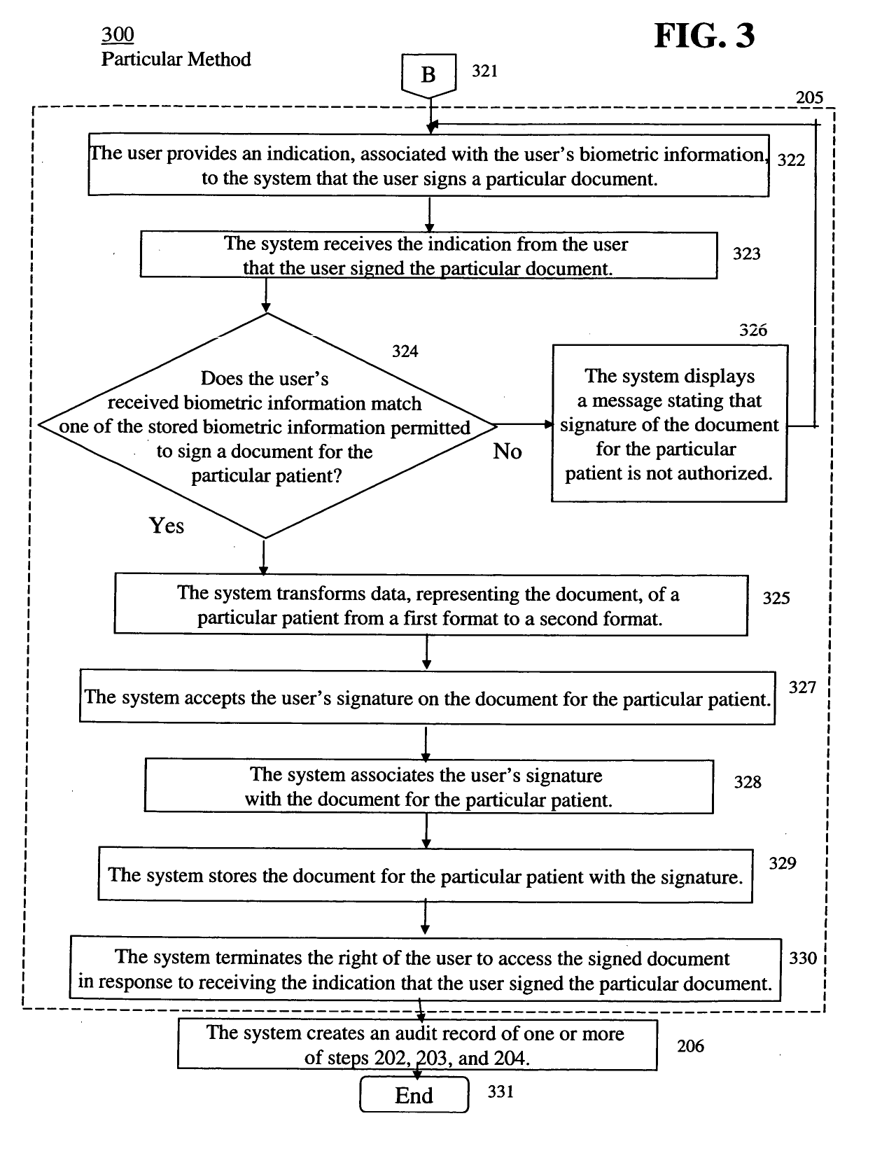

The access processor 126 authenticates and authorizes access by a user 107 to requested medical information 144 of a particular patient in response to the activity of the compare processor 124. Optionally, the access processor 126 may also be configured to terminate access rights of the matching user (see step 330 in FIG. 3) in response to an indication from the signing processor that the document is signed, and prompt the user 107 for re-entry of biometric identification information in response to a subsequent command to access patient medical information.

Authentication is the process by which a computer, computer program, or another user attempts to confirm that the computer, computer program, or user from whom the second party has received some communication is, or is not, the claimed first party. For example, the system 100 determines whether or not the user 107 is, or is not, who he is claimed to be.

Authorization is a part of the operating system that protects computer resources by only allowing those resources to be used by resource consumers that have been granted authority to use them. Resources include individual files or items data, computer programs, computer devices and functionality provided by computer applications. For example, resources in the system 100 include medical information 144, patient information 146, and documents 154.

The audit processor 128 processes and stores in the audit record 152 data identifying one or more of the following: the biometric information of said matching user 156, the patient identifier of said particular patient 158, and the time and date of access to the medical information of the particular patient 160.

The transformation processor 130 transforms data representing a document 154 concerning the particular patient in the first format 162 to data representing a document 154 in a different, second data format 164, in response to biometric information 148 received from the user 107 via the biometric interface 121.

The signing processor 132 indicates that a document 154 is signed in response to receiving biometric information 148 from the user 107, via the biometric interface 121.

The repository 106 represents any type of storage device, such as computer memory devices or other tangible storage medium, for example. The repository 106 may be implemented as a database, for example. The repository 106 represents one or more memory devices, located at one or more locations, and implemented as one or more technologies, depending on the particular implementation of the system 100.

An executable application, such as the executable application 138, comprises machine code or machine readable instruction for implementing predetermined functions including, for example, those of an operating system, a software application program, a healthcare information system, or other information processing system, for example, in response user command or input.

An executable procedure is a segment of code (i.e., machine readable instruction), sub-routine, or other distinct section of code or portion of an executable application for performing one or more particular processes, and may include performing operations on received input parameters (or in response to received input parameters) and providing resulting output parameters.

A calling procedure is a procedure for enabling execution of another procedure in response to a received command or instruction. An object comprises a grouping of data and/or executable instructions or an executable procedure.

The biometric information 140 supports automated methods for uniquely recognizing humans based upon one or more intrinsic physical or behavioral traits. Biometric authentication refers to technologies for measuring and analyzing human physical and behavioral characteristics for authentication purposes. Biometric information comprises data representing physical characteristics include fingerprints, eye retinas and irises, facial patterns, genetics, DNA, and hand measurements. Examples of behavioural characteristics include signature, gait and typing patterns. Voice is considered a mix of both physical and behavioral characteristics.

In a biometric system, the user 107 registers with the system 100 when one or more of his physical and behavioral characteristics are obtained (e.g., via the biometric interface 121), processed by a numerical algorithm (e.g., the biometric processor 122, and entered into the repository 106. Ideally, when the user 107 logs in by inputting his biometric information 148, his biometric features substantially match. The system will not allow another person to log in with different, non-matching biometric information. Current technologies have widely varying equal error rates (ERR) as low as 60% and as high as 99.9%.

Performance of a biometric measure is usually referred to in terms of a false accept rate (FAR), a false nonmatch or reject rate (FRR), and a failure to enroll rate (FTE or FER).

In real-world biometric systems, the FAR and FRR can typically be traded off against each other by changing some parameter. One of the most common measures of real-world biometric systems is the rate at the setting at which both accept and reject errors are equal, known as the equal error rate (EER), also known as the cross-over error rate (CER). The lower the EER or CER, the more accurate the system 100 is considered to be.

The user information 142 is associated with one or more users of the system 100. The user information 142 includes any information that identifies the user 107 of the system 100. The user information 142 includes, for example, name, address, phone number, fax number, employee identification number, position/title, department, internet access authorization, etc. The user information 142 represents one or more users that are permitted to have access to the system 100. The user information 142 represents known users of the system 100, such as, for example, doctors, nurses, administrators, etc.

The medical information 144 includes any information related to providing healthcare for a patient. The medical information 144 includes, for example, exams, tests, diagnosis, medical records, worksheets, reports, images, etc. Typically, a physician's review of images involves the use of worksheets and the production of a report, signed by the physician, stating the physician's findings.

The patient information 146 includes any information related to one or more patients. The patient information 146 includes, for example, name, address, phone number, patient identification number, patient's doctor, etc.

The received biometric information 148 includes any type of biometric information received from a particular user 107 of the system 100. The biometric information 148 is associated with a particular user 107 that is trying to gain access to the system 100. The particular user 107 may or may not be granted access depending on whether the particular user's biometric information 148 matches the biometric information 140 stored in the repository.

The predetermined authorization entitlement information 150 represents one or more rules to permit a particular user 107 to access the system 100. The information 150 includes, for example, a required type of biometric information 148, a combination of biometric information 148, such as biometric information 148 from two different physicians, or two different types of biometric information 148 from the same physician. The information 150 also determines type of access rights to medical information of a particular patient including, for example, one or more of the following: read and write access, read only access, and bibliographic data only access.

The audit record 152 represents information, tracked by the audit processor 128 and stored in the repository 106, about to the user's interaction with the system 100. The audit processor 128 provides Health Insurance Portability and Accounting Act (HIPAA)-compliant audit tracking.

The documents 154 represent reports related to a particular patient. A document 154 may include one or more of the following, for example: user information 142, medical information 144, and patient information 146. For example, a document may report a diagnosis of a patient's medical condition in response to a doctor examining the patient and reviewing tests run on the patient. The documents 154 further comprise data identifying a first data format 162 and a second data format 164. The format of the document includes, for example, record structure and presentation layout including text, voice, graphics, numbers, etc. The transformation processor 130 transforms a document from the first data format 162 (e.g., text) to the second data format 164 (e.g., voice).

The system 100 identifies a user 107 by the user's biometric information, thereby providing increased security and confidence in system access, medical information access, and document signing. Since the user is uniquely identified by the user's biometric information, the user 107 does not need to be in close proximity to the physical system administrating presentation and verification (e.g., signature) of the document, thereby providing an efficient and flexible way to sign documents. The system 100 advantageously permits the user 107 remotely sign documents provided by the system administrating the presentation and signature process. For example, the system 100 permits the user to sign documents, using the user's biometric information, while using the user's home computer or while using the user's portable computer or cellular telephone.

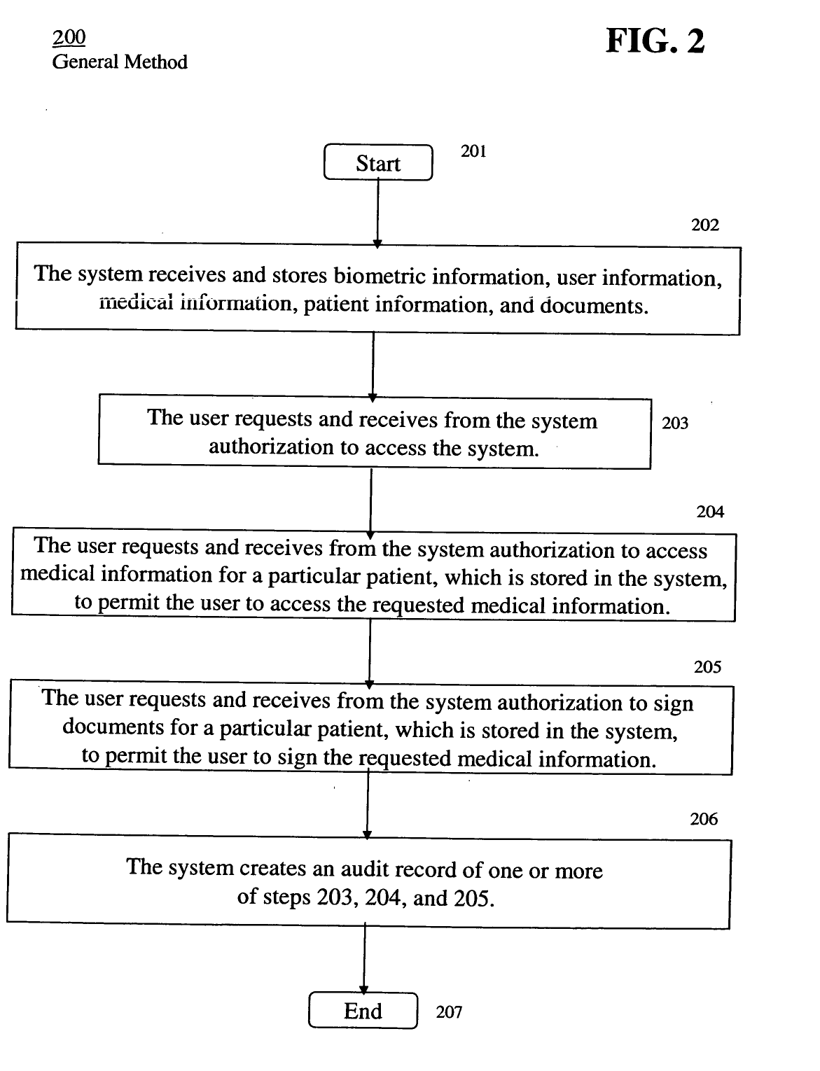

FIG. 2 illustrates a general method 200 for the system 100, as shown in FIG. 1.

At step 201, the method 200 starts.

At step 202, the system 100 receives (e.g., from data system 108) and stores (e.g., in repository 106) biometric information 140, user information 111, medical information 144, patient information 146, and documents 154. Individual biometric information 140 (e.g., finger print image for Frank Smith) corresponds to individual user information 111 (e.g., information for Frank Smith). Individual medical information 144 (e.g., diagnostic images for John Doe) and individual documents 154 (e.g., test reports for John Doe) corresponds to individual patient information 146 (e.g., information for John Doe).

At step 203, the user 107 requests and receives from the system 100 authorization to access the system 100, in response to the system 100 receiving the user's biometric information 148.

At step 204, the user 107 requests and receives from the system 100 authorization to access medical information 144 for a particular patient, which is stored in the system 100, to permit the user 107 to access the requested medical information 144, in response to the system 100 receiving the user's biometric information 148.

At step 205, the user 107 requests and receives from the system 100 authorization to sign documents 154 for a particular patient, which is stored in the system 100, to permit the user 107 to sign the documents 154, in response to the system 100 receiving the user's biometric information 148.

At step 206, the system 100 creates an audit record 152 of one or more of steps 203, 204, and 205. The audit record 152 includes successful and/or failed requests to access the system 100. The audit record 152 includes, for example, the biometric information of the matching user 156, the patient identifier of the particular patient 158, and the time and date of user access to the medical information of the particular patient 160. The audit record 152 permits the user 107 and/or other parties to review, verify, audit, manage, etc. the system 100 and/or interaction between the user 107 and the system 100.

At step 207, the method ends.

Steps 203, 204, and 205 describe three instances where the user requests and receives authorization from the system 100 for three purposes (i.e., access to the system 100, access to the requested medical information 144, and sign the requested medical information 144). The three instances of authorization represent various levels of system security, otherwise called access security levels. The access security levels, associated with a matching user, may be predetermined and stored in the repository 106. At step 203, authorization to access the system 100 represents a first level of security. At step 204, authorization to access the requested medical information 144 represents a second level of security. At step 205, authorization to sign documents 154 represents a third level of security.

Although the three security levels represent the scope the access or permission, the three security levels do not indicate relative importance among the three levels. Various other forms of security, such as user inactivity timeouts, may also be used with the method 200.

The three security levels for the same user provide safeguards that authorized user have appropriate access or permission at the appropriate time. Any number of security levels or types may be employed by the system 100.

FIG. 3 illustrates a particular method 300 for the system 100, as shown in FIG. 1. The method 300 generally includes the steps 202, 203, 204, 205, and 206, as described in the method 200 of FIG. 2. Each of the steps 203 (e.g., steps 303-309), 204 (e.g., steps 311-320), and 205 (e.g., steps 322-330) include further steps, as described in the method 300 of FIG. 3.

At step 301, the method starts.

At step 202, the system 100 receives (e.g., from data system 108) and stores (e.g., in repository 106) biometric information 140, user information 111, medical information 144, patient information 146, and documents 154, as described herein.

At step 303, the user 107 requests access to the system 100 (e.g., access to the medical information and/or the documents). The request may be in any form and performed in any manner, such as by clicking on a display icon, representing the system 100, using the user interface 102.

At step 304, the system 100 prompts the user 107 to input the user's biometric information. The prompt may be in any form and provided in any manner, such as by displaying a message, stating a request, in a display image 120.

At step 305, the user 107 inputs the user's biometric information 148 into the system 100, via the biometric interface 121.

At step 306, the system 100 receives the user's biometric information 148 from the biometric interface 121 using the biometric processor 104, and stores the user's biometric information 148 in the repository 106.

At step 307, the system 100 determines whether the user's received biometric information 148 matches one of the stored biometric information 140 associated with one of the multiple users 111. If the determination at step 307 is positive, the method 300 continues to step 308. If the determination at step 307 is negative, the method 300 continues to step 309. The system 100 makes the determination at step 307 using the compare processor 124 to compare the user's received biometric information 148 against the stored biometric information 140 associated with the multiple users 111 to determine if there is a match.

At step 308, the system 100, using the access processor 126, for example, authorizes the user 107 to access the system 100. The system 100 may confirm authorization for access in any form or manner, such as by displaying in a display image 120 a message stating that access has been authorized.

At step 309, the system 100, using the display image 120, for example, displays a message stating that the received biometric information 148 is invalid. Step 309 returns to step 304, wherein the system 100 again prompts the user 107 to input the user's biometric information 148. During the loop between step 304 and 309, the user 107 may stop trying to access the system 100, if the user continues to enter improper biometric information or if the system 100 does not have matching biometric information 140 stored for the user. If the user 107 should be able, but is not able, to access the system 100, the user may contact a system administrator to try to resolve the access problem.

At step 310, the method 300 continues from step 309 to step 311.

At step 311, the user 107 requests access to medical information 144 of a particular patient in the system 100. The system 100 permits a user 107 to request access in any form or manner, such as by clicking a display icon or entering information into a display image 120, for example.

At step 312, the system 100 prompts the user 107 to input the user's biometric information, in the same or similar manner as described in step 304.

At step 313, the user 107 inputs the user's biometric information 148 into the system 100, in the same or similar manner as described in step 305.

At step 314, the system 100 receives and stores the user's biometric information 148, in the same or similar manner as in step 306.

At step 315, the system 100 determines whether the user's received biometric information 148 matches one of the stored biometric information 140 associated with the medical information 144 for the particular patient, in the same or similar manner as described in step 307. If the determination at step 315 is positive, the method 300 continues to step 316. If the determination at step 315 is negative, the method 300 continues to step 317.

At step 316, the system 100, using the access processor 126, identifies a matching user 107 with predetermined authorized entitlement 150 to permit the user to access the medical information 144 for the particular patient.

At step 317, the system 100, using the display image 120, displays a message stating that access to the medical information 144 for the particular patient is not authorized, in the same or similar manner as in step 309. Step 317 returns to step 312, wherein the system 100 again prompts the user 107 to input the user's biometric information 148. During the loop between step 317 and 312, the user 107 may stop trying to access the system 100, if the user continues to enter improper biometric information or if the system 100 does not have matching biometric information 140 stored for the user. If the user 107 should be able, but is not able, to access the system 100, the user 107 may contact a system administrator to try to resolve the access problem.

At step 318, the system 100, using the access processor 126, authorizes the user 107 to access the medical information 144 of a particular patient in the system 100, in the same or similar manner as in step 308.

At step 319, the user 107 initiates access to the medical information 144 for the particular patient. The initiation may be in any form and performed in any manner, such as by clicking on a display icon, representing the medical information 144 for the particular patient, using the user interface 102.

At step 320, the user 107 accesses the medical information 144 for the particular patient (e.g., views, creates, modifies, prints, sends, downloads, etc.).

At step 321, the method 300 continues from step 320 to step 322.

At step 322, the user 107 provides an indication, associated with the user's biometric information 148, to the system 100 that the user 107 signs a particular document 154. The indication may be in any form and performed in any manner, such as, for example, by clicking on a display icon, before, during, or after inputting the user's biometric information 148, using the user interface 102.

At step 323, the system 100 receives the indication from the user 107 that the user 107 signed the particular document 154, using the user interface 102 and the biometric processor 104, for example.

At step 324, the system 100 determines whether the user's received biometric information 148 matches one of the stored biometric information 140 permitted to sign a document 154 for the particular patient. If the determination at step 324 is positive, the method 300 continues to step 325. If the determination at step 324 is negative, the method 300 continues to step 326. The system 100 makes the determination at step 324 using the compare processor 124 to compare the user's received biometric information 148 against the stored biometric information 140 permitted to sign a document 154 for the particular patient.

At step 325, the system 100 transforms data, representing the document, of a particular patient from a first format to a second format for the purpose of *.

At step 326, the system 100 displays a message stating that signature of the document 154 for the particular patient is not authorized. Step 326 returns to step 322, wherein the user 107 is again permitted to provide the indication. During the loop between step 322 and 326, the user 107 may stop trying to provide the indication, if the user continues to enter an improper indication (or the associated biometric information) or if the system 100 does not have matching biometric information 140 stored for the user. If the user 107 should be able, but is not able, to provide the indication (or the associated biometric information), the user 107 may contact a system administrator to try to resolve the access problem.

At step 327, the system 100 accepts the user's signature on the document 154 for the particular patient. The system 100 may accept the user's signature in any form and performed in any manner, such as by highlighting a display icon, checking a signature box, displaying a message in a display image 120, or inserting the user's digital signature on the document, for example.

At step 328, the system 100 associates the user's signature with the document 154 for the particular patient. The system 100 may perform the association in any form and in any manner, such as by digital association in a database (e.g., the repository 106), for example.

At step 329, the system 100 stores the document 154 for the particular patient with the associated user's signature in the repository 106.

At step 330, the system 100 terminates the right of the user 107 to access the signed document 154 in response to receiving the indication that the user 107 signed the particular document 154. Step 330 is for security purposes to prevent duplicate same user signing, unauthorized second user signing, etc. Hence, step 330 represents a last step in document review in that after the user 107 signs the document 154, the user 107 is finished with the document. Other variations of termination and/or last steps may also be employed, such as, for example, permitting the user 107 to have “read only” rights to review the document.

At step 206, the system 100 creates an audit record 152 of one or more of steps 203, 204, and 205, as described herein.

At step 331, the method ends.

The following two examples illustrate interaction between the user 107 and the system 100.

In a first example, a physician (i.e., the user 107) desires to read exams and create reports on a workstation. The physician signs onto the system 100 using the physician's biometric identification 148 to permit the system 100 to positively identify the physician (e.g., step 203 in FIG. 2). The physician opens a report for a particular on the workstation and reviews electronic images related to the report. When the physician finishes reading the report, the physician completes the report by marking the report as having been read by the physician. Upon the physician marking the report as read, the system 100 again prompts the physician to input the physician's biometric identification 148. The physician inputs the physician's biometric identification 148 (e.g., step 205 in FIG. 2). Input of the physician's biometric identification 148 a second time ensures a positive identification of the physician reading and signing the report. For example, if the physician is called away on an emergency and was not able to log out of workstation or sign the report, another person could not sign the report on behalf of the physician. Note in this first example that the system 100 did not request the physician's biometric identification 148 to access the medical information for the particular patient, as described in step 204 of FIG. 2. Individual requests by the system 100 for biometric identification 148 are optional and dependent on particular system design, as described in FIG. 2.

In a second example, a referring physician logs onto a workstation at a satellite facility using the referring physician's biometric information 148 to access system 100 (e.g., step 203 in FIG. 2). The referring physician requests medical information (e.g., exams and reports) for one of his patients. The referring physician again inputs the referring physician's biometric information 148 into the system 100 to receive limited access rights, such as read-only rights, to view the patient's exams and reports (e.g., step 204). The system 100 does not permit the referring physician to create reports, manipulate the exam, sign documents, etc. Note in the second example that the system 100 did not request the physician's biometric identification 148 to sign a document for the particular patient, as described in step 205 of FIG. 2.

Hence, while the present invention has been described with reference to various illustrative examples thereof, it is not intended that the present invention be limited to these specific examples. Those skilled in the art will recognize that variations, modifications, and combinations of the disclosed subject matter can be made, without departing from the spirit and scope of the present invention, as set forth in the appended claims.

What is claimed is:

1. A system for managing access to patient medical information based on biometric identification information, comprising:
a repository of biometric information for a plurality of users;
a biometric interface for receiving biometric information from a user;
an access processor for authorizing access by a user to requested medical information of a particular patient by comparing biometric information received via said interface with stored biometric information in said repository to identify a matching user with predetermined authorized entitlement to access said medical information of said particular patient;
an audit processor for storing in an audit record data identifying,
biometric information of said matching user,
a patient identifier of said particular patient and
time and date of access to said medical information of said particular patient.

2. A system according to claim 1, wherein
said predetermined authorized entitlement determines type of access rights to said medical information of said particular patient including at least one of, (a) read and write access, (b) read only access and (c) bibliographic data only access.

3. A system according to claim 1, including
a signing processor for indicating a document is signed in response biometric information received via said interface.

4. A system according to claim 3, wherein
said access processor terminates access rights of said matching user in response to an indication from said signing processor said document is signed and for prompting a user for re-entry of biometric information in response to a subsequent command to access patient medical information.

5. A system according to claim 1, including
a transformation processor for transforming data representing a document concerning said particular patient in a first format to data representing a document in a different second data format in response to biometric information received via said interface.

6. A system comprising:
a repository for storing:
biometric information, corresponding user information, and corresponding predetermined authorized entitlement information for a plurality of users; and
medical information and corresponding patient information for a plurality of patients;
a biometric interface for receiving biometric information from a user;
a biometric processor for processing and storing in the repository the biometric information received from the user;
a compare processor for comparing the biometric information received from the user against the biometric information for the plurality of users to identify a matching user; and
an access processor for authorizing access, by the matching user, to:
the system,
medical information of a particular patient, and
signature authority for a document of a particular patient;
according to predetermined authorized entitlement information and according to predetermined access security levels associated with the matching user.

7. A system, according to claim 6, further comprising:
an audit processor for storing, in an audit record, data identifying:
biometric information of the matching user,
a patient identifier of the particular patient, and
time and date of access to the medical information of the particular patient.

8. A system, according to claim 6, further comprising:
a signing processor for indicating that a document, associated with the particular patient, is signed in response the biometric information received from the user.

9. A system, according to claim 6, further comprising:
a transformation processor for transforming data representing a document concerning the particular patient in a first format to data representing a document concerning the particular patient in a different, second data format in response to the biometric information received from the user.

10. A method comprising the steps of:
receiving and storing:
biometric information, corresponding user information, and corresponding predetermined authorized entitlement information for a plurality of users; and
medical information and corresponding patient information for a plurality of patients;
receiving and storing biometric information from a particular user;
determining that the biometric information received from the particular user matches one of the biometric information for the plurality of users to identify a matching user; and
authorizing access, by the matching user, to:
the system,
medical information of a particular patient, and
signature authority for a document of a particular patient;
according to predetermined access security levels associated with the matching user.

11. A method, according to claim 10, further comprising the step of:
determining a type of access rights to the medical information of a particular patient in response to predetermined authorized entitlement information associated with the matching user.

12. A method, according to claim 11, wherein
predetermined authorized entitlement information includes at least one of the following: (a) read and write access, (b) read only access, and (c) bibliographic data only access.

13. A method, according to claim 10, further comprising the step of:
generating and storing, in an audit record, data identifying:
biometric information of the matching user,
a patient identifier of the particular patient, and
time and date of access to the medical information of the particular patient.

14. A method, according to claim 10, further comprising the step of:
receiving an indication that the particular user signed a document, associated with the particular patient, in response the biometric information received from the matching user.

15. A method, according to claim 14, further comprising the step of:
terminating access rights of the matching user in response to receiving the indication that the particular user signed the document.

16. A method, according to claim 15, further comprising the step of:
prompting a user for re-entry of biometric information in response to a subsequent command by the user to access medical information for a particular patient.

17. A method, according to claim 14, further comprising the step of:
storing the signed document in response to receiving the indication that the particular user signed the document.

18. A method, according to claim 10, further comprising the step of:
transforming data representing a document associated with the particular patient from a first format to a different, second data format in response to the biometric information received from the particular user.

19. A user interface comprising:
a data input device for receiving data from a user;
a biometric interface for receiving biometric information from the user, wherein
a repository stores:
biometric information, corresponding user information, and corresponding predetermined authorized entitlement information for a plurality of users; and
medical information and corresponding patient information for a plurality of patients;
a biometric processor processes and stores in the repository the biometric information received from the user;
a compare processor compares the biometric information received from the user against the biometric information for the plurality of users to identify a matching user; and
an access processor authorizes access, the by matching user, to:
the system,
medical information of a particular patient, and
signature authority for a document of a particular patient,
according to predetermined authorized entitlement information and according to predetermined access security levels associated with the matching user; and
a data output device for generating data, representing the authorized access and the medical information of the particular patient, for the matching user.

20. A user interface, according to claim 19, wherein each of the data input device and the data output device further comprises:
a display for presenting a display image providing a graphical user interface permitting the user to input data and to view data.
